(19) United States
(12) Patent Application Publication
(10) Pub. No.: US 2004/0158542 A1
(43) Pub. Date: Aug. 12, 2004

(54) Viterbi decoder

(76) Inventor: Nikolaus Bruls, Redwood City, CA (US)

Correspondence Address: GERO G. McCLELLAN, MOSER, PATTERSON & SHERIDAN, L.L.P., Suite 1500, 3040 Post Oak Blvd., Houston, TX, 77056, US

(21) Appl. No.: 10/723,292

(22) Filed: Nov. 26, 2003

(30) Foreign Application Priority Data
Nov. 28, 2002 (DE) 102 55 426.9-35

(51) Int. Cl. G06F 15/18

(52) U.S. Cl. 706/1

(57) ABSTRACT

A Viterbi decoder is described, having a calculation unit (ACSU) for a Radix-2^{x} trellis which, for each trellis state, adds the respectively associated 2^{x} branch metrics (ZMi) to the already accumulated 2^{x} path metrics (PMM) from 2^{x} predecessor trellis states, and selects those of the 2^{x} path metrics (PMi) which have been determined in this way to be extreme as the new accumulated path metric (PMM) for the addition process in the next period, with said calculation unit containing:

for each trellis state, 2^{x} parallel cascades of processor elements (PE) for pipeline processing of the bits in the branch metrics and in the path metrics (PMM) and, for each trellis state, in each case one extreme value selection device (MAX) for all the processor elements of the same order (q) within the pipeline. According to the invention, the number of processor elements (PE) in each of the cascades is less than the number m of the bits which are used for the binary number representation of the value range of the path metrics (PM).

For this purpose, process or elements in each cascade are designed such that they in each case process disjunct groups of p≧2 bits cohesively.

### CROSS-REFERENCE TO RELATED APPLICATIONS

This application claims foreign priority benefits under 35 U.S.C. §119 to co-pending German patent application 102 55 426.9-35, filed Nov. 28, 2002. This related patent application is herein incorporated by reference in its entirety.

### BACKGROUND OF THE INVENTION

1. Field of the Invention

The invention relates to a decoder for decoding convolutional codes, as claimed in the preamble of patent claim 1.

2. Description of the Related Art

The following description relating to the prior art refers to the following sources from the specialist literature:

[1] G. D. Forney, jr. “The Viterbi Algorithm”; Proc. IEEE, Vol. 61, No. 3, March 1973, pp. 268-278.

[2] P. Black et al. “A 140-Mb/s, 32-state, Radix-4 Viterbi Decoder”; IEEE Journal OF Solid-State Circuits, Vol. 27, No.12, December 1992, pp.1877-1885.

[3] G. Fettweis et al. “A 100 Mbit/s Viterbi Decoder Chip: Novel Architecture and its Realization”; Proc. IEEE ICC, Vol. 2, Atlanta August 1990, pp.1877-1885.

[4] A. Yeung et al. “A 210 Mb/s Radix-4 Bit-level Pipelined Viterbi Decoder”, 1995 IEEE International Solid-State Circuits Conference, pp. 88-89.

[5] V. S. Gierenz et al. “A 550 Mb/s Radix-4 Bit-Level Pipelined 16-State 0.25-μm CMOS Viterbi Decoder”; Proc. IEEE Inter.Conf. on Application-Specific Systems, Architectures, and Processors; Boston, July 2001, pp.195-201.

[6] R. Krambeck et al. “High-Speed Compact Circuits with CMOS”; IEEE Journal OF Solid-State Circuits, Vol.SC-17, No. 3, June 1982, pp. 614-619.

So-called convolutional codes are being increasingly used for transmission of a sequence of digital data from a message source via a channel which is subject to interference to a message sink. A convolutional coder links each element or “word” in the original sequence from the source on the basis of a selected function with a specific number of the respectively directly preceding words, in order to output a sequence of transmission words which have a greater bit width than the words in the original sequence. This redundancy in the transmission words makes it possible to identify any corruptions in the transmission words in the received words at the reception end, and also to correct them.

If the elected logic function which uniquely defines the code is known, then, specifically, it is possible to determine the extent to which a group of two or more successive received words “fits” into the scheme of the code. To do this, a convolutional decoder has to compare the word group with all those “permissible” word groups which theoretically (for all possible original sequences) could have been received if the coder had been operating correctly and there had been no interference with the transmission. These comparisons are used to determine so-called “metrics” which indicate how close to or far away from the individual permissible word groups the received word group is, that is to say how probable or improbable it is that the received word group has originated from the compared, permissible word group. In a further comparison operation, all the metrics determined in this way are compared with one another, and the permissible word group for which the determined metric indicates the greatest probability is selected as the valid word group.

The distance function on which the metric calculation is based is preferably matched to the characteristics of the transmission channel that is used and the form of modulation that is used. This is done on the basis of theoretical probability analyses. The distance function may be designed such that the metric becomes smaller the closer the comparison objects approach one another. In this case, the permissible word group for which the metric is a minimum is selected as the valid word group; decoding is thus carried out by selection of the minimum. The distance function may, however, also be designed such that the metric becomes greater the closer the comparison objects approach one another. In this case, the permissible word group for which the metric is a maximum is selected as the valid word group (decoding by selection of the maximum).

Of all the feasible algorithms for carrying out the convolutional decoding process as described above, the so-called Viterbi algorithm has now been introduced in practice, and its general principle is described, for example, in [1].

### SUMMARY OF THE INVENTION

The present invention relates to the circuitry embodiment of a Viterbi decoder operating using this algorithm.

### BRIEF DESCRIPTION OF THE DRAWINGS

In order to assist understanding of the invention, the basic principle of Viterbi decoders and their construction according to the prior art will be explained first of all with reference to FIGS. 1 to 10.

FIG. 1 shows a diagram of the handling of a Radix-2 trellis with 4 states for digital transmission;

FIG. 2 shows a diagram of the handling of a Radix-2 trellis with 4 states for analog transmission;

FIG. 3 shows the most important component elements of a Viterbi decoder;

FIG. 4 shows the transformation of the diagram as illustrated in FIG. 1 to a Radix-4 trellis with 4 states;

FIG. 5 shows the transformation of the diagram as illustrated in FIG. 2 to a Radix-4 trellis with 4 states;

FIG. 6 shows an example of a Radix-4 trellis with 8 states;

FIG. 7 shows the general scheme of a Viterbi decoder with a Radix-4 trellis which has 8 states;

FIG. 8 shows, in the form of a block diagram, the general configuration of, and the mutual connections between, processor elements in a Radix-4 Viterbi decoder, which operates with bit pipelining, according to the prior art;

FIG. 9 shows the configuration of one of the processor elements illustrated in FIG. 8, in more detail;

FIG. 10 shows the critical path between the processor elements, as illustrated in FIG. 8.

FIG. 11 shows an outline block diagram of the configuration of two successive processor elements for an ACSU designed according to the invention, where p=2, that is to say with a 2-bit architecture;

FIG. 12 shows one of the processor elements from FIG. 11, illustrated in more detail;

FIG. 13 shows the components of the critical path in the ACSU designed according to the invention in an isolated form; and

FIG. 14 shows an example of a dynamic circuit technique.

### DETAILED DESCRIPTION OF THE PREFERRED EMBODIMENT

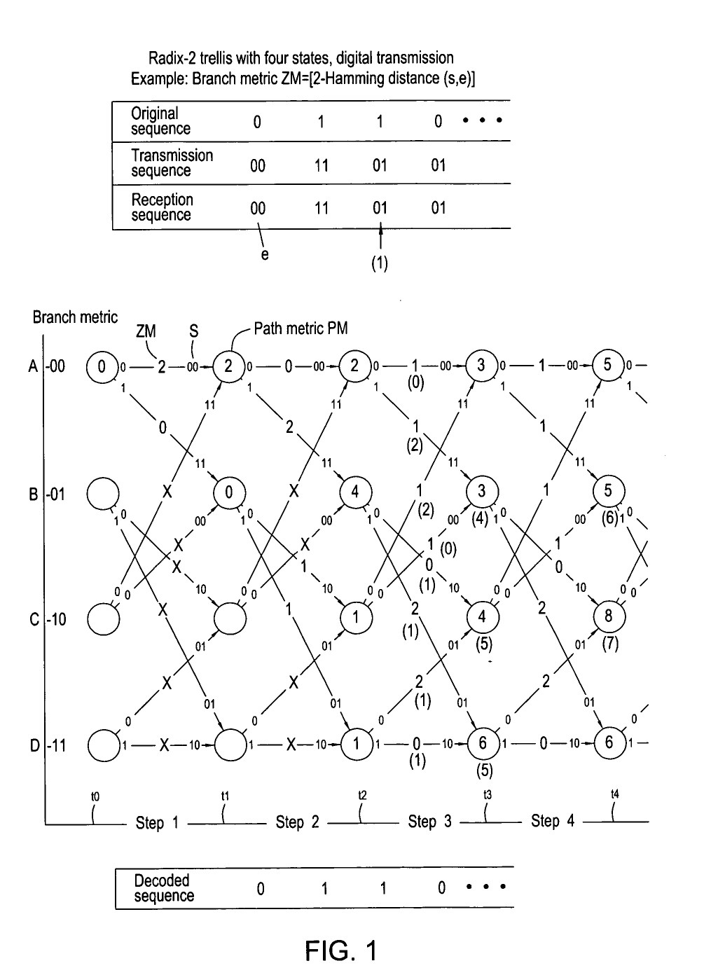

The Viterbi algorithm is based on a so-called “trellis” which uniquely describes the convolutional code that is used, in the form of a branch diagram. FIG. 1 shows a trellis for a convolutional code which uses an original sequence whose elements each comprise only one bit to form a transmission sequence whose elements each comprise 2 bits. The four possible states (00, 01, 10, 11) of the respective latest two bits in the original sequence are referred to as “trellis states” and are plotted along the ordinate, on the coordinates A, B, C, D. Time markers t0, t1 . . . of a clock are plotted along the abscissa. The diagram shows nodes as circles, which form a matrix composed of rows (in the direction of the abscissa or time axis) and columns (in the direction of the ordinate). Each node represents a trellis state which is determined by the row position (ordinate) of the node in the diagram. Two branches, which are represented as arrows, lead from each of the four nodes in a column to two nodes in the subsequent column. Hence the name “Radix-2” trellis.

The logic linking rule for the code is indicated in FIG. 1 by binary numbers (written in plain text) at the origins and ends of the branch arrows. The single-digit binary number (0 or 1) at the start point of a branch represents the binary value of a new bit in the original sequence, and is referred to in the following text as the “input number”. The two-digit binary number at the end of the branch indicates the new output state (binary values of the two new bits in the transmission sequence) which results as a consequence of the new input number for the original sequence; this number is referred to in the following text as the “output number”. If, for example, the trellis state, that is to say the latest two bits in the original sequence, is equal to 00 (an A node) and a new bit is added to the binary value 1, then this results in the new trellis state 01 (branch with the input number 1 from the A node in one column to the B node in the next column), and the new output value becomes 11, as shown at the end of the relevant branch. If, on the other hand, the new bit in the original sequence has the value 0, so that the new trellis state is also equal to 00 (branch from the A node in one column to the A node in the next column), then the output number is 00. In a similar way, the designations which are determined by the convolutional code can also be identified on the basis of the inscriptions in FIG. 1, between on the one hand each of the three other possible trellis states and the new bit in the original sequence and, on the other hand, the resultant new output number.

The route of the branches between the nodes in two adjacent columns and the input numbers and output numbers that are shown on the branches are the same in each column pair and describe the convolutional code uniquely and completely. The representation of only one column pair is thus sufficient as a trellis to describe the code. However, FIG. 1 shows more than two successive columns along the time axis, that is to say a time development of the trellis in order to indicate the development of the 2-bit output numbers in the transmission sequence from an example of an original sequence with the width of 1 bit.

As an example, let us consider an original sequence of the bit sequence 0-1-1-0 . . . , as is shown in the table above the diagram. As the defined initial situation, let us assume that the trellis state before the first bit in the original sequence is equal to 00 (A node in the first column). The first bit in the original sequence under consideration is 0, and this leads to the new trellis state 00 (the A node in the second column) and to the first output number 00 for the transmission sequence. The second bit in the original sequence is 1, and this leads to the new trellis state 01 (B node in the third column) and to the second output number 11 for the transmission sequence. The third bit in the original sequence is likewise 1, and this leads to the new trellis state 11 (the D node in the fourth column) and to the third output number 01 for the transmission sequence. The fourth bit in the original sequence is 0, and this leads to the new trellis state 10 (the C node in the fifth column) and to the fourth output number 01 for the transmission sequence. The coded transmission sequence 00-11-01-01— . . . is thus formed from the original sequence 0-1-1-0 . . . , as is shown in the table above the diagram. The branches which are passed through during the coding steps that have been described form, when considered together, a “path” which passes transversely through the trellis diagram, is characteristic for the original sequence, and is emphasized in bold in FIG. 1.

This characteristic path can be reconstructed during the decoding at the reception end, to be precise by analysis of the received version of the transmission sequence. The steps in the Viterbi algorithm used here for this purpose will be described in the following text using the coding example shown in FIG. 1.

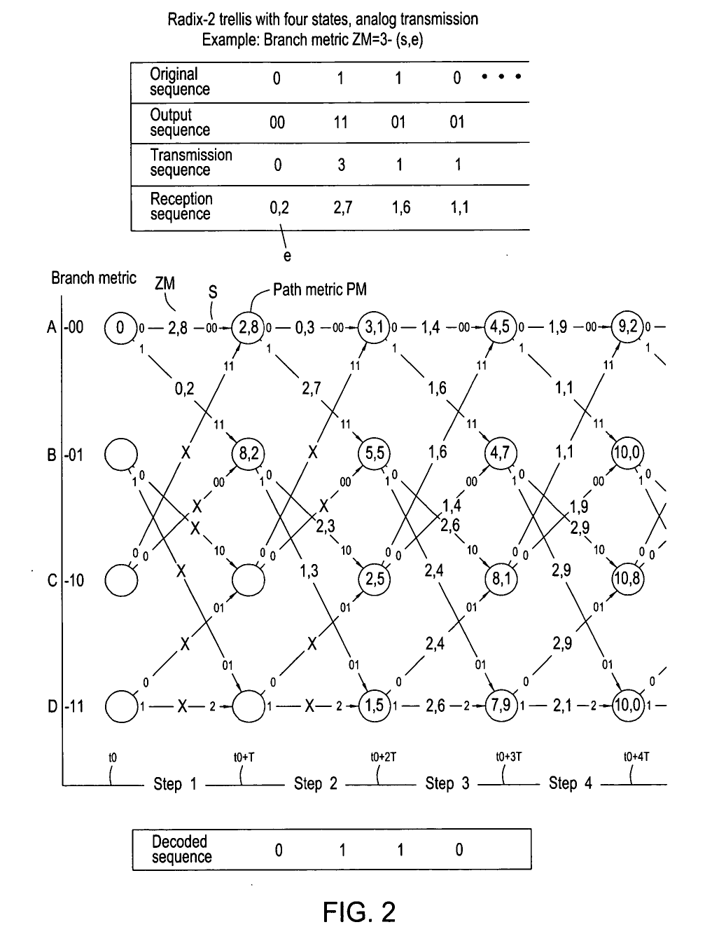

First of all, let us assume that the output numbers in the transmission sequence are transmitted in digital form as 2-bit words. The only possible effect of a transmission error is thus that individual bits in the reception sequence may be inverted. The “branch” metric of all (eight) branches between adjacent columns in the trellis shown in FIG. 1 is determined with respect to a received symbol whenever each received symbol appears, that is to say with each 2-bit word in the reception sequence. The output numbers that are shown at the end of the branches in FIG. 2 are used as the basis for this. If, as in the assumed situation, transmission errors can appear only as a bit inversion, it may be sufficient to determine the number of matching bits in the compared candidates as the branch metric (corresponding to 2 minus the Hamming distance). If all the bits match, the branch metric is equal to 2, if only 1 bit matches, the branch metric is equal to 1, and if none of the bits match, the branch metric is equal to 0.

In FIG. 1, the branch metrics ZM are shown as decimal numbers written in bold text on all of those branches which could be passed through in all the possible reception sequences if a start is made at the trellis state 00 (the A node in the first column in FIG. 1), corresponding to the initial situation defined above. The branches of all those paths which originate exclusively from the nodes B, C and D in the first column thus differ from the start. This means that the relevant branches are “impossible”, and that their branch metrics must still be ignored; they are therefore annotated “X” in FIG. 1.

The first step at the reception end, that is to say the processing of the first received symbol, starts at the A node in the first column. The second column contains only the nodes A and B at which there are “possible” input branches, to be precise in each case only one. The metrics for these branches are stored as “path metrics” PM for the relevant nodes and these are shown in FIG. 1 as bold decimal numbers within the circles that represent the nodes.

New path metrics are in each case determined and stored for all the nodes in each of the following steps. Two algebraic sums are determined in order to determine the respective new path metrics which are shown within the circles that represent the relevant trellis nodes: for each of the two input branches at the node, the sum of the branch metric for this branch and the path metric for the original node in this branch. The two sums are compared, and the greater of the two is stored as the accumulated new path metric for the relevant node. Only that input branch which preceded this new path metric remains of interest as the “survivor” of the relevant node for the reconstruction of the characteristic path.

If an “impossible” input branch opens at a node, this branch must, of course, still have no influence on the path metric calculation. This can be achieved, for example, simply by setting the path metrics before this first step (that is to say at the node in the first column) such that the path metric at the start node A in the first column is greater by at least the magnitude of the maximum possible branch metric (that is to say by at least the number 2 in the case of FIG. 1) than at the other nodes in the first column. If, by way of example, the path metric 0 is selected for the start node A in the first column, as is illustrated in FIG. 1, then the path metrics of the other nodes in this column can be set to the negative number −(≧2). Alternatively, of course, the path metric for the start node can also be set to ≧2, and the path metrics for the other nodes can be set to 0.

On the basis of the entries in the trellis nodes in FIG. 1, it can be seen that the characteristic path can be reconstructed from end by in each case moving back from that node in a column whose path metric is the greatest to that node in the preceding column which has the maximum path metric there. The sequence of the input numbers for the branches of this path thus reproduces the original sequence.

Owing to the redundancy in the coding, the characteristic path is resistant to a certain degree of transmission errors. Let us assume, for example, that, during reception, the first bit 0 of the third transmission symbol has been received incorrectly as 1 (or has been incorrectly assessed as 1), as is shown in brackets ( ) in FIG. 1. In the decoding step 3, this then results in the branch metrics indicated in brackets, which leads to the changes to the path metrics as indicated in brackets. As can be seen, the reconstruction of the characteristic path leads, however, to the same result as for error-free transmission. The original sequence is therefore reproduced correctly despite said transmission error.

In many cases, the transmission sequence is transmitted in the form of analog values rather than digitally. For the original sequence 0-1-1-0 as shown in FIG. 1, this means that the digital words 00-11-01-01 which are output from the convolutional coder are converted to the corresponding analog values 0-3-1-1 in order, for example, to modulate a transmission voltage within a range between 0 and 3 volts, as is shown in FIG. 2. At the receiving end, this voltage is sampled synchronously. Owing to unavoidable distortion and other interference in the transmission channel, the sample values will not correspond with high precision to the values in the transmission sequence, but will differ from them to a greater or lesser extent. FIG. 2 shows the situation in which the reception-end sample values 0,2—2,7—1,6—1,1 are obtained from the transmission sequence 0-3-1-1.

The decoding based on the Viterbi algorithm is in this case carried out in a very similar manner to that in the case shown in FIG. 1, with the only exception being that the path metrics are determined arithmetically rather than from the two's complement of the Hamming distance. The path metrics may thus, for example, be established by determining the magnitude of the difference between the output number, which is written in the form of a decimal number in FIG. 2, and the received sample value, and subtraction of this magnitude from any given fixed value which is equal to or greater than the maximum possible sample value. In FIG. 2, the branch metrics ZM determined in this way as well as the respectively resultant maximum path metrics PM are shown for the situation in which said fixed value is equal to 3. It is self-evident that the path which is traced back during decoding from the end via the respectively greatest path metrics (chain of lines shown in bold) corresponds precisely to the characteristic path by means of which the original sequence is recovered exactly, despite the fact that the sample values in the reception sequence differ from those in the transmission sequence.

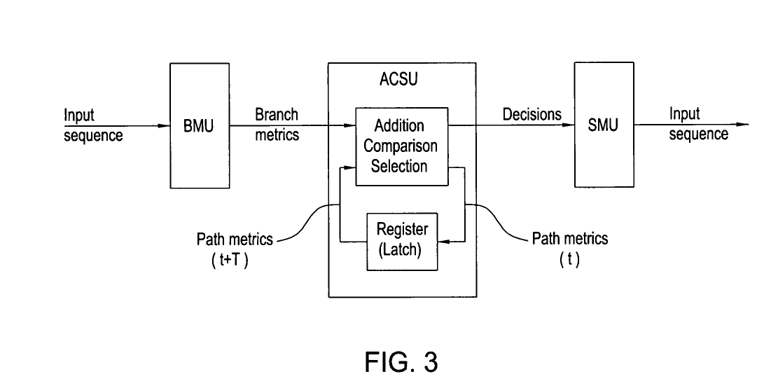

As is evident from the basic description above, a Viterbi decoder overall requires the module elements shown as blocks in FIG. 3: firstly a branch metric calculation device, normally referred to for short as a BMU (Branch Metric Unit), which receives the input sequence (reception sequence) and which is programmed with the trellis of the convolutional code that is used, in order to calculate the branch metrics in the trellis as a function of the input sequence; secondly, an adder-comparison-selection device, normally referred to for short as an ACSU (Add Compare Select Unit), for calculation of the path metrics by means of the addition and comparison processes described above and for making the decision with regard to the selection of the respective maximum path metric for the trellis nodes; thirdly a path memory, normally referred to for short as an SMU (Survivor Memory Unit), for storage of the decisions which are made in the ACSU and which denote the respective survivors from which the characteristic path can then be reconstructed in order to recover the original sequence.

The branch metrics can be calculated in parallel in the BMU for all the states A, B, C and D in the trellis, that is to say at all the nodes along a column. Each new path metric is determined in the ACSU by selection of the respective highest sum of the preceding path metric and the new branch metrics, as has been described above with reference to FIG. 1. The ACSU therefore requires a feedback loop with a memory register for the preceding path metric, as is shown in FIG. 3. This feedback loop results in the ACSU being particularly critical for the time response of the decoder, which limits the throughput. “Pipelining” (that is to say conveyor belt processing with the insertion of pipeline registers for intermediate values), which increases the throughput, for the addition comparison selection operation for the individual paths is not possible in the ACSU owing to the data dependency of successive calculation steps. This is because the path metrics for an input symbol cannot be calculated until the path metrics for the previous input symbol are available. A further important boundary condition for the solution of the throughput problem is the restricted energy budget (requirement to consume as little energy as possible, for example owing to a simple plastic housing) and owing to the requirement for as cost-effective an implementation as possible in a standard CMOS process. For this reason, bipolar or ECL technology (which is admittedly fast but is expensive and consumes large amounts of power) is generally not feasible. However, various architectural approaches to improve the throughput of the decoder are known from the literature.

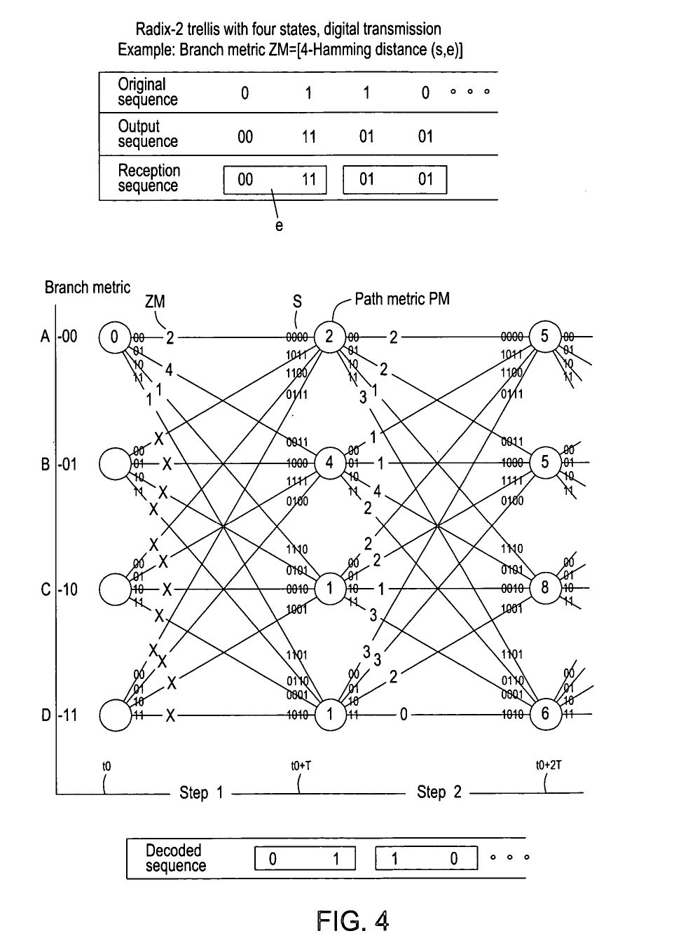

A first approach for improving the throughput is to use a Radix-4 trellis rather than a Radix-2 trellis as is illustrated in FIG. 1 (in each case two branches at the input and output of the trellis nodes), which Radix-4 trellis in each case has four branches at the input and output of the trellis nodes, as is described, for example, in [2]. FIG. 4 shows the time development of a Radix-4 trellis, applicable to the same convolutional code and the same original and transmission sequences as in FIG. 1. Comparison of FIGS. 1 and 4 shows that, in the Radix-4 trellis, two successive small steps in the Radix-2 trellis are in each case combined to form a single, large step. In FIG. 4, the nodes which apply to the start and end of the large step 1 correspond to those nodes in FIG. 1 which apply there to the start of the small step 1 and to the end of the small step 2. The nodes which apply to the start and end of the large step 1 in FIG. 4 correspond to those nodes in FIG. 1 which apply there to the start of the small step 3 and to the end of the small step 4.

The combination of in each case two steps as shown in FIG. 4 results in the number of output branches and the number of opening branches at each node being doubled from 2 to 4. In a corresponding manner, the input numbers which are shown at the starts of the branches and identify the branch also each have twice as many bits as in FIG. 1, that is to say 2 bits. The output numbers which are shown at the ends of the branches in FIG. 4 and are characteristic of the code have 4 bits. Four successive bits in the reception sequence are compared with the output numbers in all of the branches in each decoding step in order to determine the respective branch metric. The branch and path metrics and the characteristic path for the example of an original sequence considered here are also shown in FIG. 4 as decimal numbers written in bold text and by a train of lines which are emphasized by thick lines. It is also evident in this case that the path which is traced back during decoding from the end via the respectively largest path metrics (the train of lines which are shown by thick lines), corresponds precisely to the characteristic path by means of which the original sequence is recovered. It can easily be seen that this is also applicable when transmission errors occur, in precisely the same way as in FIG. 1.

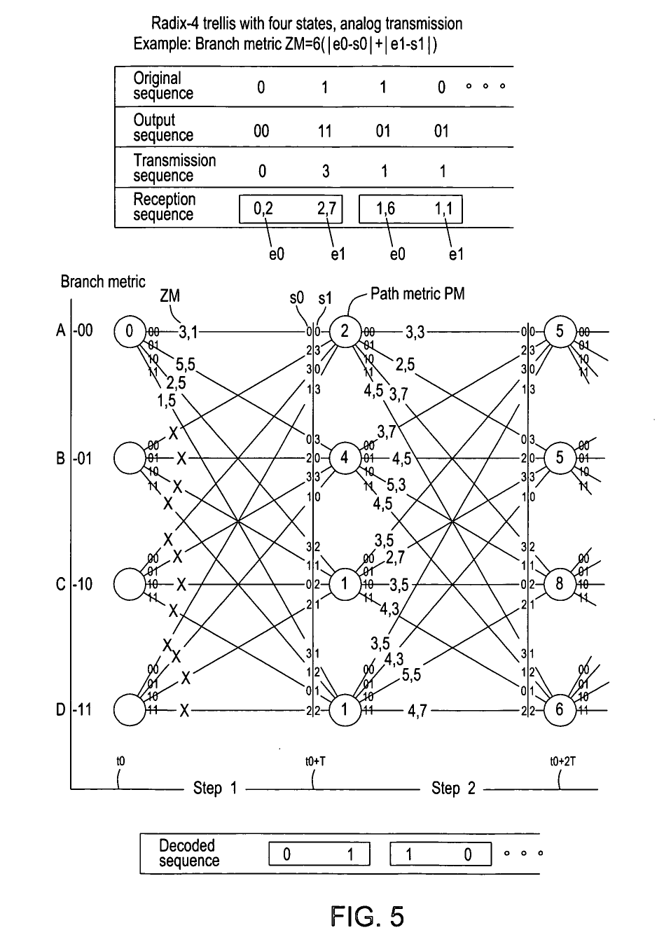

FIG. 5 shows the Radix-4 trellis for the situation in which analog values are used for transmission and the reception sequence is obtained by sampling the received analog signal, as has been described above in conjunction with FIG. 2. In a similar way to that in the case of the Radix-4 trellis shown in FIG. 3, two successive received symbols are in each case processed in a common “large” step in this case as well. In each step, the branch metrics are obtained from the sum of the magnitude of the difference between the respective first received symbol e0 and the higher-value part s0 of the output number and of the magnitude of the difference between the respective second received symbol e1 and the lower value part s1 of the output number (with the values s0 and s1 being in each case written in decimal form in FIG. 5). Said sum is subtracted from a fixed amount which, in the described example, is selected to be equal to 6, that is to say having twice the magnitude of that in FIG. 2. This therefore results in the same path metrics as in FIG. 2.

The change from the Radix-2 trellis to a Radix-4 trellis for decoding results in twice as much time being available for each step. However, there are four possible predecessor states for each trellis state in the Radix-4 trellis, so that the comparison of the path metrics and the selection of the respective maximum path metric for finding the most probable predecessor state and thus for as correctly as possible reconstructing the characteristic path are more complicated. However, this results in a throughput gain overall.

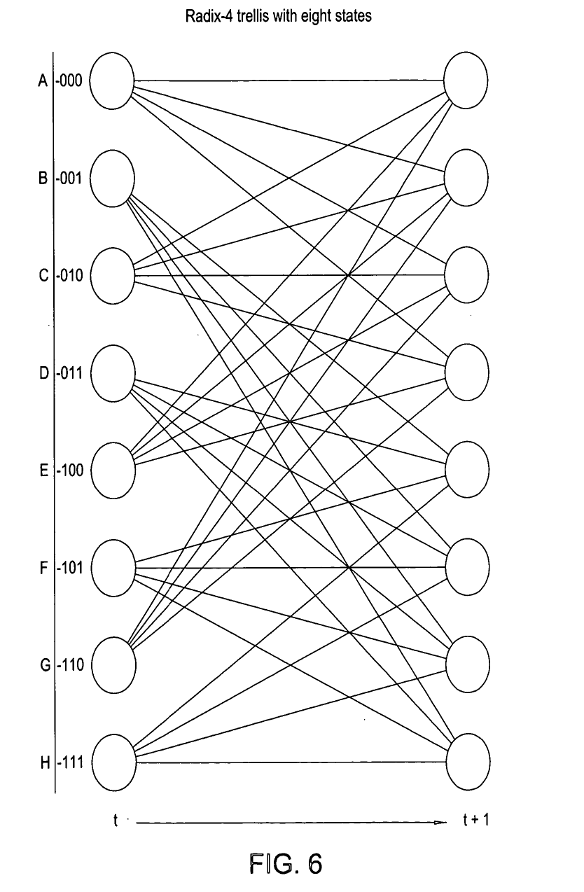

Convolutional codes and Viterbi decoders matched to them are, of course, not restricted to only four trellis states A to D. FIG. 6 shows an example of a Radix-4 trellis with eight states A to H, as is described in [2]. Convolutional codes and Viterbi decoders with even more trellis states are likewise possible, for example with 16 or 32 trellis states. However, in any case, four branch metrics are used for processing each trellis state, as long as this is a Radix-4 trellis. FIG. 6 does not show the four input numbers at the origins of the branches, which correspond to the input numbers in FIG. 4 or FIG. 5, in order to avoid confusing the drawing. For the same reason, FIG. 6 omits those output numbers which describe the code at the ends of the branches.

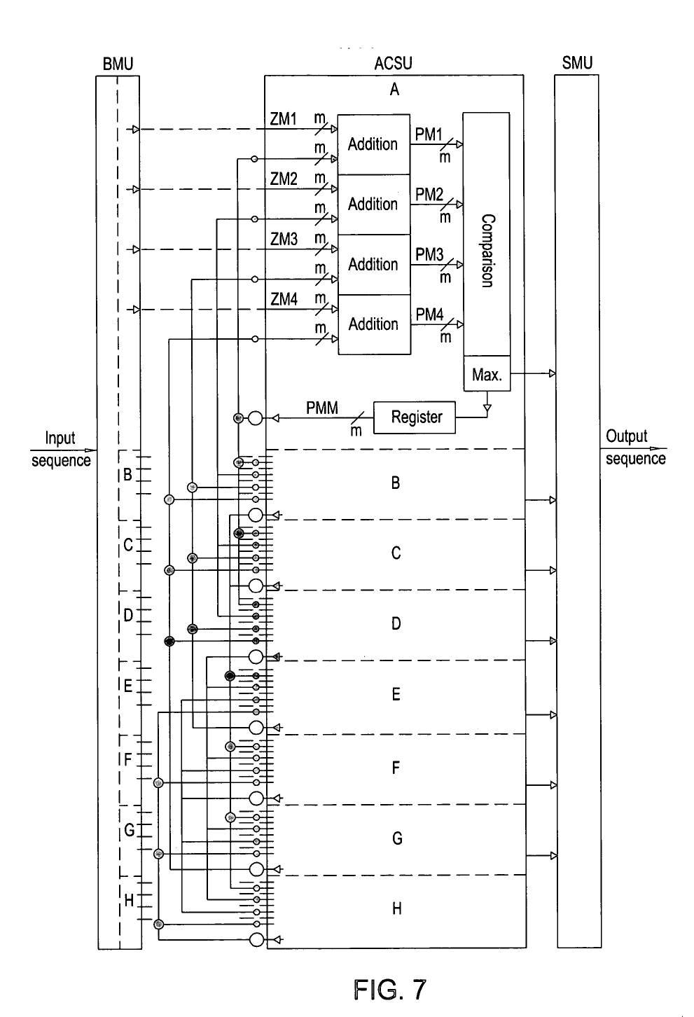

The general configuration of a Viterbi decoder as shown in FIG. 3 is illustrated in somewhat more detail in FIG. 7 for the example, as shown in FIG. 6, of a Radix-4 trellis with eight trellis states A, B, C, D, E, F, G, H. In a corresponding manner, the ACSU contains eight sections A to H, in order to calculate the maximum accumulated path metric PMM(t) for each trellis state during each clock interval i of the period duration T. This calculation is carried out by addition of each of the four branch metrics ZM1 to ZM4 which are supplied from the BMU for this clock interval, to the maximum path metric PMM, which is associated with the relevant branch, from the preceding calculation process, mutual comparison of the four addition results and selection of the maximum. FIG. 7 shows only the section A (for the trellis state A) in more detail. In this section, the branch metric ZM1 is added to the maximum path metric PMM from the same section; ZM2 is added to the PMM from the section C; ZM3 is added to the PMM from the section G, and ZM4 is added to the PMM from the section G, which corresponds to the trellis diagram shown in FIG. 6. The association between the branch metrics ZM1:4 and the respective path metrics PMM to be added in the other sections B to H is, of course, different to that in the section A, to be precise in each case as predetermined by the trellis diagram.

Since the values of the accumulated path metrics PM become ever larger as the process of addition of the branch metrics ZM continues from one clock cycle to the next, the value range of the path metrics PM is greater than the value range of the branch metrics ZM. The bit width “m” of the processing devices in the ACSU must therefore be matched to the value range of the path metrics PM. FIG. 7 shows the same number “m” for the bit width both for the path metrics and for the branch metrics. This means that a binary-coded branch metric value represented in the form of a binary number is changed to have the bit width m by the insertion of preceding 0 bits.

In each of the eight ACSU sections A to H, the value of the maximum determined there is stored in the register of the relevant section as a new maximum path metric PMM for the next step. The information as to which of the four path metrics PM1 to PM4 in one section is the respective maximum path metric PMM denotes the survivor for the relevant trellis state. These eight survivor information items are stored in the SMU.

One particular problem occurs when the variables which are processed in the ACSU are multidigit numbers. Even in the case of analog transmission and sampling of the reception sequence, the further processing of the sample values, that is to say their comparison with the output numbers that describe the code and the subsequent metric calculations, is, in practice, once again carried out by means of digital technology, of course. For this reason, the sample values must be digitized. In order to achieve high accuracy, a high degree of resolution in the digitization process is desirable, which generally means a relatively large bit width and thus a large number of digits or a long word length of the digitized branch metrics ZM, and thus also of the accumulated path metrics. When multidigit binary numbers are being added in the ACSU, the “carry propagation”, that is to say the accumulation and passing on of the carry bits from the last digit LSB to the first digit MSB, requires a number of miniature steps. This so-called “ripple” lengthens the addition process as the word length or bit width becomes greater.

One known approach for reducing the ripple effect that has been mentioned and thus for further improving the throughput of the Viterbi decoders is the “bit-pipelining” with “carry save” representation described in [3], that is to say conveyor belt processing the bits with redundant representations in order to save the carry process. In this case, the addition and comparison in the ACSU are carried out bit-by-bit starting with the MSB, that is to say starting with the bit with the highest digit value, on the basis of redundant numerical representation for the path metric, with the addition process being carried out without continuous carry propagation. A further development which is known from [4] comprises the maximum identification being reduced to a simple OR logic operation by recoding the redundant numerical representation of the path metrics. Finally, as is known from [5], the comparison can be carried out in parallel at the bit level, with all four path metrics PM1 to PM4 which are determined for one trellis state in the Radix-4 trellis being compared in parallel with the three other path metrics. This comparison process can be carried out locally for each branch, and thus very efficiently and quickly. The decision for each branch with two bits is coded on the basis of the redundant numerical representation: one expresses a “preliminary” (that is to say provisional) decision, and the other expresses a “final” decision.

The combination of all four described measures for improving the throughput, that is to say:

i) change to a Radix-4 trellis,

ii) pipelining with redundant numerical representation,

iii) maximum identification by means of an OR function,

iv) parallel comparison at the bit level,

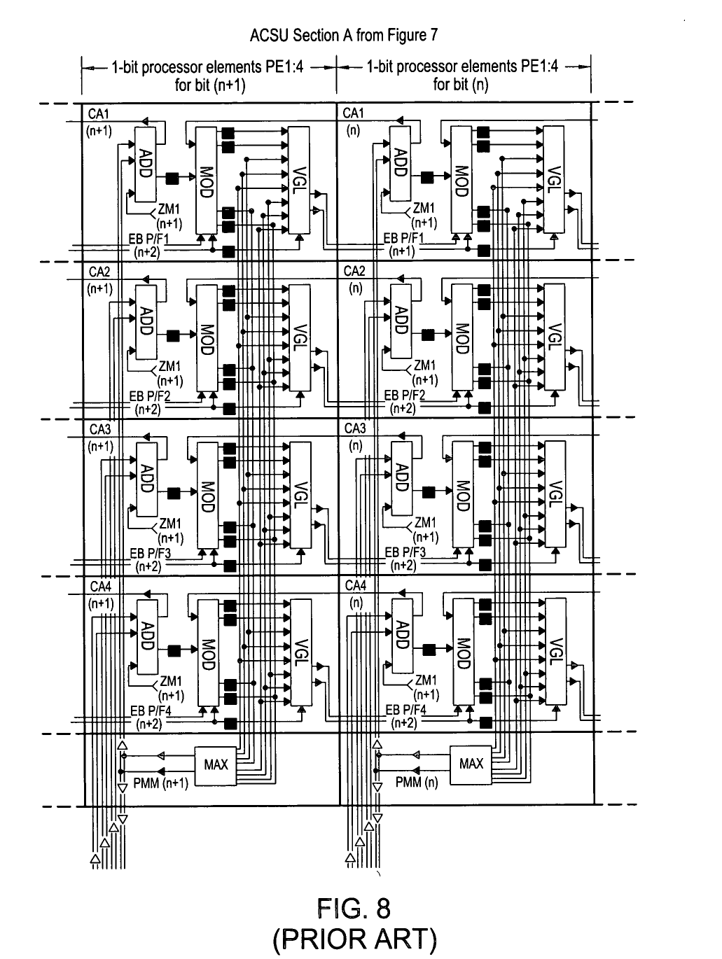

at the moment represents the prior art for the CMOS implementation for the most stringent throughput requirements with a moderate energy consumption at the same time. FIG. 8 uses a block diagram to show how a section of the ACSU according to the prior art illustrated in FIG. 6 is configured, to be precise specifically using the example of the section A. All eight sections are constructed in the same way, and they differ only by which of the eight maximum path metrics PMM are in each case added to the four branch metrics ZM that are processed in them.

According to FIG. 8, a cascade of series-connected processor elements PE is provided for each of the four branch metrics ZM1 to ZM4. Each processor element PE within the cascade calculates one of the m path metric bits from the associated bit of the relevant branch metric. Each cascade thus contains m processor elements, so that the arrangement for each trellis state comprises a total of 4 times m processor elements. The illustration shows only two of these, one of which is associated with any given n-th bit with the digit value 2ⁿ within the m-bit word, and the other of which is associated with the (n+1)-th bit (next higher digit value 2ⁿ⁺¹). Each processor element contains three functional blocks: an addition block ADD, a notation modification block MOD and a comparator block VGL. All four processor elements which are each associated with the same bit digit value have connections via an 8-core distribution cable harness both to one another and to 8 inputs of a maximum identification block MAX.

In the following figures as well as the following description, processor elements and the bits which are involved with processing them are identified by abbreviations in the form of capital letters followed by a suffix. The suffix contains an Arabic numeral 1, 2, 3 or 4 (or, in general “i”) which indicates the association with the respective branch metric ZM1, ZM2, ZM3 or ZM4 (or, in general ZMi), and the bracketed expression indicates the association with the bit digit value of the relevant branch metric word. A colon “:” between two subsequent suffix symbols denotes “to”.

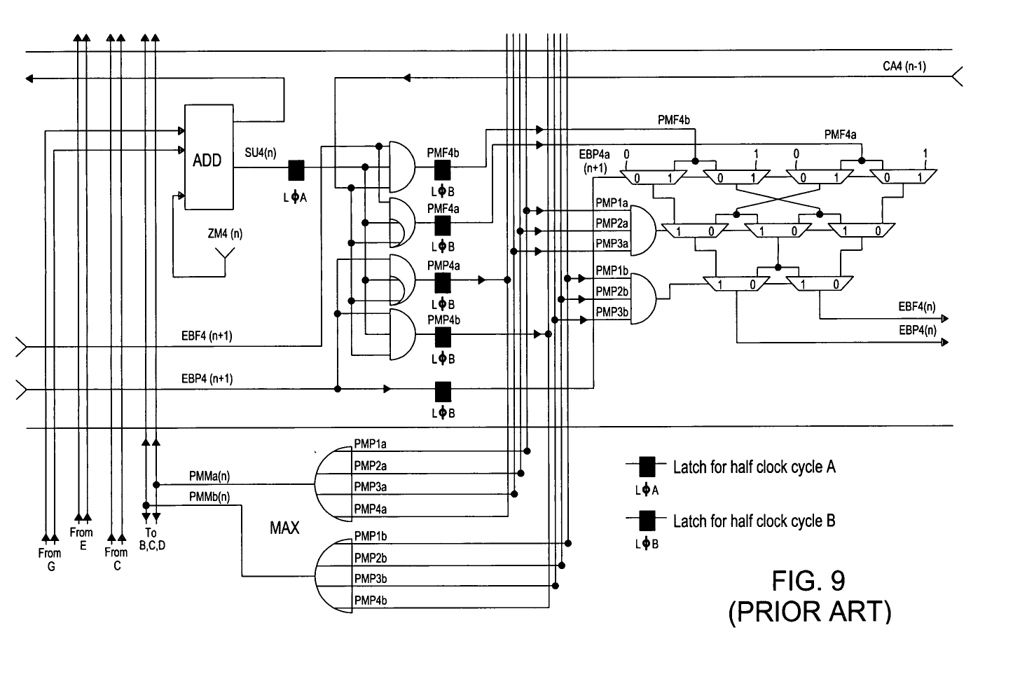

The configuration and method of operation of the functional blocks ADD, MOD and VGL are the same in all the processor elements. FIG. 9 shows in detail, as an example that is representative of all the processor elements, the configuration specifically of the processor element PE4(n), that is to say of the processor element for the n-th bit in the branch metric ZM4, together with the functional block MAX(n).

During operation, the processor elements in a cascade PE(MSB:LSB) operate staggered in time by half one clock cycle T/2 from left to right, that is to say starting with the MSB (most significant bit) and continuing as far as the LSB (least significant bit). In each processor element PE(n) the block ADD receives the associated bit n of the branch metric ZMi and a redundant 2-bit representation PMMa:b(n) for the bit n of the maximum path metric. The block ADD supplies a sum bit SUi(n) which is passed on at half the clock rate ΦA via a latch circuit LΦA, and a carry bit CAi(n) which is fed back to the preceding processor element PE(n+1) in the same row.

The block MOD has a sum bit input in order to receive the sum bit SU which is passed on at half the clock rate ΦA, a carry input to which the carry bit is fed back from the block ADD of the subsequent processor element in the same cascade, and, furthermore, two decision bit inputs for receiving a preliminary decision bit EBP(n+1) and a final decision bit EBF(n+1), which are produced by the block VGL in the preceding processor element PE(n+1). The block MOD, which comprises a system of AND gates and OR gates, logically links these four received bits in order to produce four output bits: a redundant preliminary 2-bit representation PMPa:b for the bit n of the path metric, and a redundant final 2-bit representation PMFa:b for the bit n of the path metric. The truth tables relating to this are as follows:

TABLE 1

| | | | | | |
|---|---|---|---|---|---|
| CA(n − 1) | x | 0 | 0 | 1 | 1 |
| SU(n) | x | 0 | 1 | 0 | 1 |
| EBP(n + 1) | 0 | 1 | 1 | 1 | 1 |
| PMPa(n) | 0 | 0 | 1 | 1 | 1 |
| PMPb(n) | 0 | 0 | 0 | 0 | 1 |

TABLE 2

| | | | | | |
|---|---|---|---|---|---|
| CA(n − 1) | x | 0 | 0 | 1 | 1 |
| SU(n) | x | 0 | 1 | 0 | 1 |
| EBF(n + 1) | 0 | 1 | 1 | 1 | 1 |
| PMFa(n) | 0 | 0 | 1 | 1 | 1 |
| PMFb(n) | 0 | 0 | 0 | 0 | 1 |

In this case, x represents an “undefined value”. The four MOD output bits PMPa:b and PMFa:b are passed on via the latch circuits LΦB at half the clock rate ΦB. The latch circuits LΦA and LΦB thus act as pipeline registers.

In detail, the preliminary path metric bits PMPa:b from the block MOD are passed on at half the clock rate ΦB to an associated pair of conductors in the 8-core distribution cable harness. This distribution cable harness contains a total of four different core pairs, each of which is associated with one, and only one, of the four processor elements PE1:4(n).

The final path metric bits PMFa:b are passed on at half the clock rate ΦB to the comparator block VGL. The VGL block receives, at the same half clock rate, the result of an OR logic operation on the preliminary path metric bits PMPa of the three other processor elements PE, and the result of an OR logic operation of the preliminary path metric bits PMPb of the three other processor elements PE, with these bits being derived from the relevant core pairs in the distribution cable harness. The block VGL furthermore receives, at half the clock rate ΦB, the preliminary decision bit EBP(n+1) for the previous processor element PE(n+1). The VGL block contains a system of multiplexers, in order to produce the preliminary decision bit EBP(n) and the final decision bit EBF(n).

The block MAX contains two OR gates, in order to produce the two bits PMMa:b(n) for the redundant 2-bit representation of the bit n for the maximum path metric. One of the OR gates receives all four preliminary path metric bits PMP1:4a(n) from the four processor elements PE1:4(n) and sets the bit PMMa(n) to the binary value 1 when, and only when, at least one of these four received bits is equal to 1. The other OR gate receives all four preliminary path metric bits PMP1:4b(n) from the four processor elements PE1:4(n) and sets the bit PMMb(n) to the binary value 1 when, and only when, at least one of these four received bits is equal to 1.

The ACSU system which has been described above with reference to FIGS. 8 and 9, according to the prior art, operates as follows in each of the sections A to H, in order to derive the decision relating to the new maximum path metric for each trellis state A to H from the four m-bit words of input path metrics ZM1:4 and from the information relating to the old path metric PPM which has been accumulated prior to that:

An initialization process is carried out before the start of operation, by setting all of the decision bits EBPi and EBFi and all of the bits for the maximum path metrics PMMia:b in all of the processor elements to 0. The successive m bit words for the branch metrics ZM which are supplied from the BMU are then applied at time intervals T, to be precise with each word ZMi in a “time-staggered parallel format” with the bits within the same word being offset with respect to one another by half the clock rate interval T/2, in accordance with the scheme shown in the following table:

TABLE 3

| ΦA | ΦB | ΦA | ΦB | ΦA | . . . |
|---|---|---|---|---|---|
| Word 1 | | Word 2 | | Word 3 | . . . |
| ZMi | | ZMi(m − 1) | | ZMi(m − 1) | |
| (m − 1) | | | | | |
| | Word 1 | | Word 2 | | . . . |
| | ZMi(m − 2) | | ZMi(m − 2) | | |
| | | Word 1 | | Word 2 | . . . |
| | | ZMi(m − 3) | | ZMi(m − 3) | |
| | | | Word 1 | | . . . |
| | | | ZMi(m − 4) | | |
| | | | | Word 1 | . . . |
| | | | | ZMi(m − 5) | |

The m bits 2^{m-1}, 2^{m-2}, 2^{m-3}, . . . , 2⁰ of each branch metric word are thus clocked successively at half the clock rate interval T/2 into the cascade, starting with the MSB, and pass through the pipeline formed in this way at the clock frequency 2/T. When the bit 2^{m-1} (that is to say the MSB) of the first branch metric word appears, all the decision bits in the first cascade stage, that is to say the bits EBPi(m−1) and EBPi(m−1), are set to the binary value 1, and are kept at this value throughout the entire subsequent time.

In each of the processor elements PEi(n), the branch metric bit ZMi(n) is added in the ADD block to the 2-bit number PMMa(n), PMMb(n) for the maximum path metric PMM(n) from the respectively responsible ACSU section, the maximum of the four new path metrics is selected, and the two decision bits EBPi(q) and EBFi(q) are formed for each of the four branches. The branch metric bit ZMi(n) in this case covers the value range (0:1)*2ⁿ (the symbol * is the multiplication sign), and the 2-bit number PMMa:b(n) is a modified representation of the associated bits of the new maximum path metric; this number covers the value range (0:2)*2ⁿ. The output of the ADD block covers the value range (0:3)*2ⁿ, with the carry bit CAi(n) being passed on with the value 2*2ⁿ to the preceding processor element PE(n+1). A path metric bit representation with the value range (0:2)*2ⁿ is thus produced once again at the input of the MOD block, formed by the sum bit SU(n) and the carry bit CA(n−1) of the subsequent processor element PE(n−1).

The MOD block modifies this numerical representation as follows:

TABLE 4

| | |
|---|---|
| Input information from MOD | Modified |

| | | |
|---|---|---|
| Numerical value | Input bits | representation |

| decimal | dual | SU | CA | a | b |
|---|---|---|---|---|---|
| 0 | 00 | 0 | 0 | 0 | 0 |
| 1 | 01 | 0 | 1 | 1 | 0 |
| | | 1 | 0 | | |
| 2 | 10 | 1 | 1 | 1 | 1 |

The representation that has been modified in this way makes it possible to use the described two 4-OR logical operations in the MAX block to obtain the redundant 2-bit representation PMMa:b(n) of the maximum of the total of four preliminary 2-bit path metric representations PMP1a:b(n), PMP2a:b(n), PMP3a:b(n) and PMP4a:b(n).

The decision bits EBPi(n) and EBFi(n) are formed in the blocks MOD and VGL in accordance with the following logic rule:

TABLE 5

| EBFi(n + 1) | EBPi(n + 1) | DIFFi(n) | EBFi(n) | EBPi(n) |
|---|---|---|---|---|
| 1 | 1 | −2 | 0 | 0 |
| | | −1 | 1 | 0 |
| | | ≧0 | 1 | 1 |
| 1 | 0 | ≦0 | 0 | 0 |
| | | +1 | 1 | 0 |
| | | +2 | 1 | 1 |
| 0 | 0 | X | 0 | 0 |

Here, DIFFi(n) indicates the maximum difference between the final path metric PMFi(n), which is represented by the 2 bits PMFia:b(n), and the 3 preliminary path metrics PMj(n) which originate from the three other processor elements PEj(n), and each of which is represented by the 2 bits PMPja:b(n), where j=1, 2, 3, 4 except for i. X denotes an “undefined value”.

When EBFi(n) has the value 0, then this is assessed as information relating to definitive exclusion of the relevant branch i. The combination EBFi(n)=1 and EBPi(n)=0 is assessed as information relating to an intended exclusion. The combination EBFi(n)=1 and EBPi(n)=1 states that the relevant branch will presumably be the survivor. The preliminary and final decision bits are calculated starting with the MSB for the branch metric (that is to say for the (m−1 )-th bit) and are passed on until, finally, the unambiguous decision is made with the LSB (that is to say with the 0-th bit).

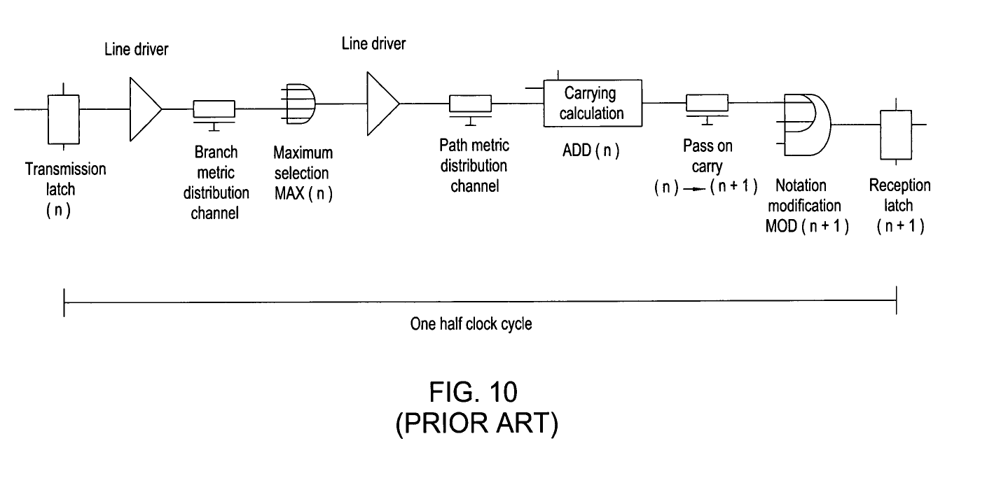

As can be seen from FIGS. 8 and 9, there are relatively long lines for the distribution of the signals between the gates, so that corresponding line drivers are required. These drivers are not shown in FIGS. 8 and 9 for reasons of clarity, although they are shown in FIG. 10, which shows the “critical path”, that is to say the longest signal path in time from one register (or latch) to the next. This signal path is thus that which limits the maximum possible speed of the overall system. Speed increases (clock frequency increases) can be achieved only by speeding up this critical path until, finally, a different path is the most critical.

Even though the known ACSU architecture as shown in FIGS. 8 and 9 relating to the throughput and power loss represents the optimum of the moment, this does not allow the more stringent requirements relating to advanced data transmission systems to be complied with satisfactorily. This applies in particular to the new generation of hard disk controllers which are currently being developed and which are intended to operate at data rates of more than 2000 MBit/s.

This description of the prior art has been based on an example in which the metrics are based on a distance function which must be decoded by selection of the maximum. The problems addressed are, however, the same if a distance function is used in which the minimum has to be selected rather than the maximum. In any case, that metric which is the “extreme” in the sense already defined must be found for each trellis state from two or more accumulated metrics, with this predetermined sense being related either to the maximum or the minimum, depending on the nature of the selected distance function.

The object of the invention is to design a Viterbi decoder which operates using bit pipelining, such that it has the capability for higher throughput rates than are possible with the previous prior art. According to the invention, this object is achieved by the features specified in patent claim 1.

Accordingly, the invention is implemented in a Viterbi decoder which is designed to decode a convolutional code on the basis of a Radix-2^{x} trellis with 2^{z} states, where x and z are integers ≧1, and with the decoder essentially containing three calculation units. The first calculation unit uses periodically successive multibit words in an input sequence to determine the 2^{x} branch metrics as multibit words for each trellis state. The second calculation unit, the so-called ACSU, adds the respectively associated 2^{x} branch metrics to the already accumulated 2^{x} path metrics from 2^{x} predecessor trellis states for each trellis state in each clock period, and selects those of the 2^{x} path metrics which have been determined in a preselected sense to be extreme as the new accumulated path metric for the addition process for the next period. The third calculation unit is designed to store the information obtained from the second calculation unit relating to the identity of the path metrics which are selected in the second calculation unit in the successive clock periods. The second calculation unit contains parallel cascades of processor elements for each trellis state 2^{x}, which are connected in series for pipeline processing of the bits of the branch metrics and of the extreme path metrics, progressively with the decreasing digit value of the bits. Furthermore, the second calculation unit in each case contains an extreme value selection device for each trellis state, for all of the processor elements of the same order within the pipeline. The invention is distinguished in that the number of processor elements in each of the cascades is less than the number m of the bits which are used for the binary number representation of the value range of the path metrics, in that each of the cascades in each case contains a number INT(m/p) of processor elements corresponding to the integer number of m/p, where p is an integer equal to or greater than 2 and less than m, and with each of these INT(m/p) processor elements within the cascade being associated with one, and only one, of INT(m/p) successive disjunct p-bit groups of the m bits.

The quotient m/p may be an integer, or not an integer. In the former case, INT(m/p) is equal to m/p, and each cascade need comprise only a total of m/p processor elements, each of which is associated with a p-bit group, that is to say in each case one of the m/p successive disjunct “p-tuples” of the m bits. It is always possible to ensure that m/p is an integer by ensuring that the bit width m which is used for the path metrics is made up, if necessary, to an integer multiple of p by preceding it by zero bits, for any given number p. However, it is also possible for the quotient m/p not to be an integer. In this case, a further processor element must be provided in each cascade in addition to the INT(m/p) processor elements which are each associated with one p-bit group, with this further processor element being associated with the remaining bits, the number of which, r is less than p. This processor element is preferably associated with the r most significant or r least significant digit values in the m bit sequence.

Those metrics which are “extreme in the preselected sense” may either be the respective maximum or the respective minimum metrics, depending on the type of distance function which is used for determining the branch metrics.

The invention thus specifies an ACSU architecture that has been modified from that in the prior art. Instead of the known 1-bit processor elements, multibit bit processor elements are used, that is to say p-bit processor elements where 2≦p<m, preferably where p=2. Initially, this appears to be contradictory to the success which is generally promised from the principle of bit pipelining. However, it has been found that an improvement in throughput and further advantages as well can actually be achieved by the multibit architecture according to the invention. In the case of a multibit architecture according to the invention, only 1/p as many processor elements are required for a given bit width m than with the known 1-bit architecture. This reduces the latency time of the pipeline to 1 p-th of that of the known 1-bit solution. Furthermore, the available energy budget per processor element is p-times as great.

However, the ≧2-bit architecture considerably increases the complexity of the calculations, which would normally have a negative effect on the speed and on the maximum throughput rate. However, the particular embodiment of the invention counteracts this possible disadvantage by introducing a new, redundant numerical representation, by which means it is possible to keep the critical path relatively short as in the case of the known architecture, particularly when the extreme value selection is the selection of the maximum. However, this in fact makes the complexity of the individual gate stages greater. According to one advantageous refinement of the invention, however, the process can be speeded up significantly by using dynamic circuit techniques such as the DOMINO logic that is known from the literature [6], without overall involving any additional surface area or increased energy.

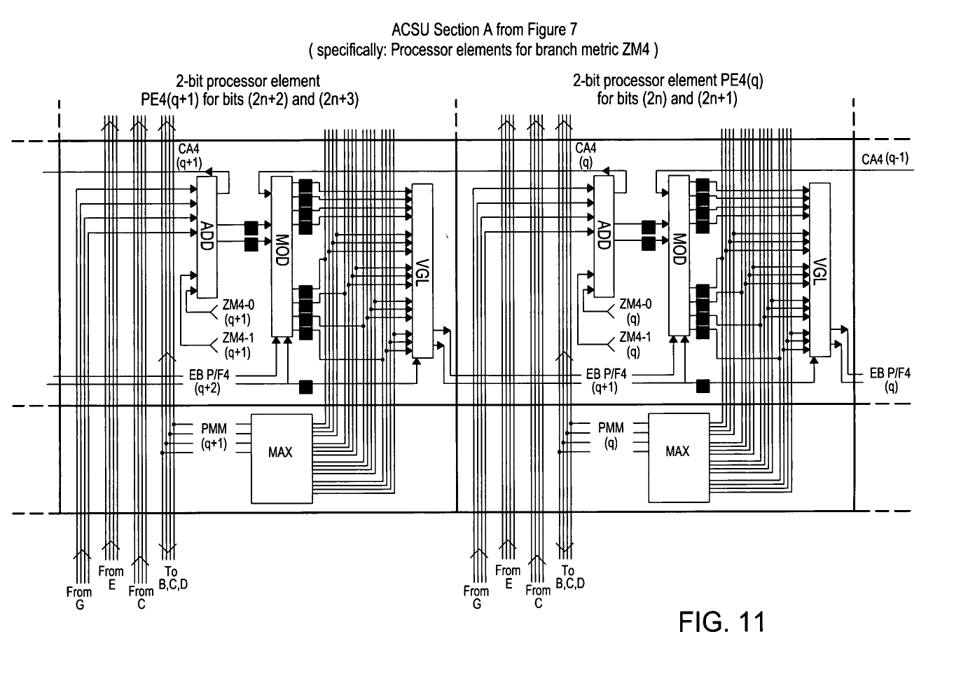

The invention will be explained in more detail in the following text using an exemplary embodiment and with reference to FIGS. 11 to 14.

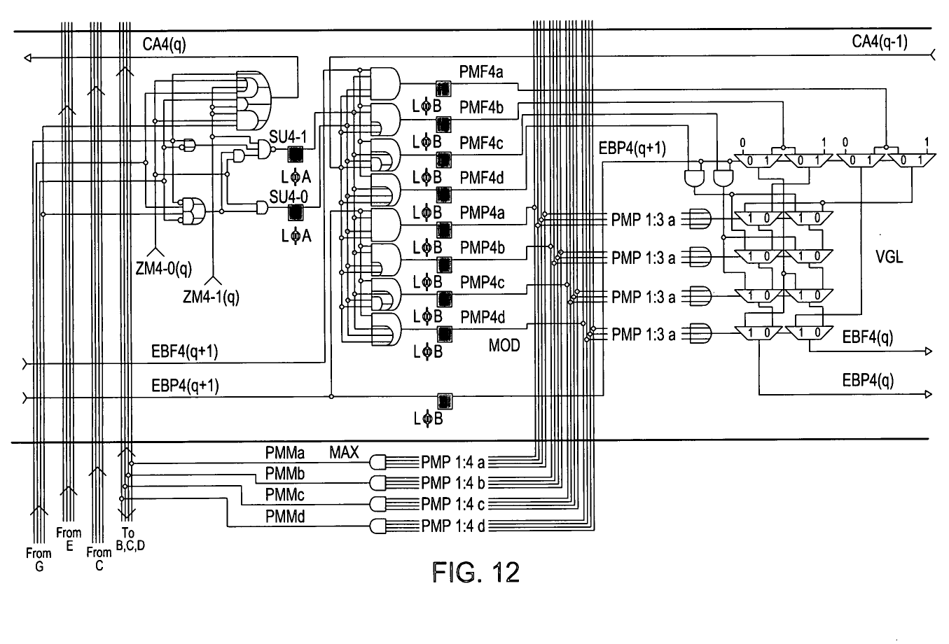

The exemplary embodiment of the invention as described in the following text relates in precisely the same way as the example of the prior art described above to the configuration of an ACSU section for a Radix-4 trellis with 8 states, in order to determine the new maximum path metric PMM(t+T) for one trellis state from the branch metrics ZM1:4 of the four input branches and from the old maximum path metrics PMM(t) of the predecessor trellis states which are associated with the input branches. Certain aspects of the circuit blocks which are shown in FIGS. 11 and 12 are similar to the blocks from the prior art shown in FIGS. 8 and 9 and are therefore designated with the same abbreviations as those used there; the same applies to the signal bits and their abbreviated designations that are used.

One major difference from the prior art is that, in the described exemplary embodiment, each processor element in each case processes two bits of an m-digit path metric word; therefore, p=2. Furthermore, it is assumed that m/p is an integer, that is to say that m is an integer. Accordingly, m/2 processor elements are provided for each of the path metrics PM1:4. 1≦n≦m is the order of the successive bits, counting from the least significant bit LSB, and 1≦q≦m/2 is the order of the directly successive disjunct bit pairs, counting from the least significant bit pair. An indeterminate processor element PE(q) processes the q-th bit pair, that is to say the 2n-th bit and the (2n+1)-th bit. The preceding processor element PE(q+1), if it exists, processes the (q+1)-th bit pair, that is to say the (2n+2)-th bit and the (2n+3)-th bit. The subsequent processor element PE(q−1), if it exists, processes the (q−1)-th bit pair, that is to say the (2n−2)-th and the (2n−1)-th bit. In the following description and in the FIGS. 11 and 12, the least significant bit in each bit pair is identified by the symbol “−0”, and the most significant bit is identified by the symbol “−1” within the suffix of the bit name.

The total of m/2 times 4 processor elements for the four branch metrics ZM1:4 all have the same configuration and form an arrangement comprising four rows. As a representative example of all the processor elements, FIG. 11 shows two adjacent processor elements PE4(q) and PE4(q+1) for the q-th bit pair and for the (q+1 )-th bit pair of the branch metric ZM4, to be precise specifically for the ACSU section A which is associated with the trellis state A. The illustration also shows the blocks MAX for production of those bits which signal the maximum PMM(q) and PMM(q+1), respectively, of the path metric bits from all of the processor elements PE1:4(q) and PE1:4(q+1), respectively, of the ACSU section A. FIG. 12 shows the details of the configuration of the processor elements based on the example of the processor element PE4(q).

During operation, each row of m/2 series-connected processor elements operates staggered in time by in each case half the clock cycle T/2 offset from left to right, that is to say starting with the most significant bit pair, and continuing to the least significant bit pair.

In each processor element PEi(q), the block ADD receives the q-th bit pair ZMi-0(q), ZMi-1(q) of the branch metric ZMi and a redundant 4-bit representation PMMia:d(q) for the q-th bit pair for the maximum path metric. The block ADD produces two sum bits SUi-0 and SUi-1, which are passed on at half the clock rate ΦA and a carry bit CAi which is fed back to the preceding processor element PE(q+1) in the same row. The block ADD contains the system (as shown in FIG. 12) of gates with logic functions AND, NAND, OR, exclusive-OR (XOR) and exclusive NOR (XNOR), in order to form the sum of the path metrics PMMia:d(q) which are contained in the 4-bit thermometer representation, and the branch metrics ZMi-0:1(q) which are in the form of 2-bit binary number representation. The outputs SUi-0, SUi-1 and CAi represent this sum in a binary number representation, with SUi-0 having the value 2²ⁿ, SUi-1 having the value 2⁽²ⁿ⁺¹⁾, and CAi having the value 2⁽²ⁿ⁺²⁾.

The block MOD has two sum bit inputs for reception of the sum bits SU-0 and SU-1 which are passed on at half the clock rate ΦA, a carry input to which the carry bit is fed back from the block ADD in the downstream processor element PEi(q−1) and, furthermore, two decision bit inputs for reception of a preliminary decision bit EBP(q+1) and of a final decision bit EBF(q+1), which are produced by the block VGL in the preceding processor element PE(q+1). The block MOD, which comprises a system of AND gates and OR gates, logically links these four received bits in order to produce eight output bits: a redundant preliminary 4-bit representation PMPa:d for the q-th bit pair of the path metric and a redundant final 4-bit representation PMFa:d for the q-th bit pair of the path metric.

The logic function of the MOD block is such that the binary value 0 of a decision bit from the preceding processor element PEi(q+1) “masks” the respectively associated group of four MOD output bits from the processor element PEi(q), that is to say likewise sets them to 0. This means that, when the preliminary decision bit EBPi(q+1) has the binary value 0, then all four outputs bits PMFia:d(q) are set to 0, and when the final decision bit EBFi(q+1) has the binary value 0, then all four output bits PMFia:d(q) are set to 0.

The eight MOD output bits PMPia:d and PMFia:d are passed on via the illustrated latch circuits LΦB at half the clock rate ΦB. In detail, the four preliminary path metric bits PMPia:d are passed on from the block MOD at half the clock rate ΦB to an associated group of four conductors in a 16-core distribution cable harness. This distribution cable harness contains a total of four different groups of four conductors, each of which is associated with one, and only one, of the four processor elements PE1:4(q).

The four final path metric bits PMFia:b(q) are passed to the comparator block VGL at half the clock rate ΦB. Once again at half the clock rate, the VGL block receives the result of an OR logic operation on the primary path metric bits PMPja from the three other processor elements PEj(q), the result of an OR logic operation on the preliminary path metric bits PMPjb from the three other processor elements PEj(q), the result of an OR logic operation on the preliminary path metric bits PMPjc from the three other processor elements PEj(q) and the result of an OR logic operation on the preliminary path metric bits PMPjd from the three other processor elements PEj(q). The block VGL furthermore receives the preliminary decision bit EBPj(q+1) from the preceding processor element PEj(q+1) at half the clock rate ΦB. The VGL block contains a system of multiplexers, in order to produce the preliminary decision bit EBPj(q) and the final decision bit EBFj(q).

The block MAX contains four OR gates, in order to produce the four bits PMMia:d(q) for the redundant 4-bit representation of the q-th bit pair for the maximum path metric. The first OR gate receives all four preliminary path metric bits PMP1:4a(q) from the four processor elements PE1:4(q), and sets the bit PMMa(q) to the binary value 1 when and only when at least one of these four received bits is equal to 1. The second, third and fourth OR gates link the preliminary path metric bits PMP1:4b(q) and PMP1:4c(q) and PMP1:4d(q) from the four processor elements PE1:4(n) in accordance with the same rule.

The new ACSU system that has been described above with reference to FIGS. 11 and 12 operates as follows, in order to derive the decision relating to the new maximum path metric for each trellis state A to H from the four m-bit words of the input path metrics ZM1:4 and from the information relating to the old path metric PMM accumulated so far:

An initialization process is carried out before the start of operation, by setting all the decision bits EBPi and EBFi and all of the bits for the maximum path metrics PMMia:d in all of the processor elements to 0. Successive m-bit words are then applied to the branch metrics ZM supplied from the BMU at time intervals T, to be precise such that successive disjunct bit pairs within the same word are offset with respect to one another by half the clock rate interval T/2, according to the scheme shown in the following table:

TABLE 6

| ΦA | ΦB | ΦA | ΦB | ΦA | |
|---|---|---|---|---|---|
| Word 1 | | Word 2 | | Word 3 | . . . |
| ZMi | | ZMi(m − 1) | | ZMi(m − 1) | |
| (m − 1) | | (m − 2) | | (m − 2) | |
| (m − 2) | | | | | |
| | Word 1 | | Word 2 | | . . . |
| | ZMi(m − 3) | | ZMi(m − 3) | | |
| | (m − 4) | | (m − 4) | | |
| | | Word 1 | | Word 2 | . . . |
| | | ZMi(m − 5) | | ZMi(m − 5) | |
| | | (m − 6) | | (m − 6) | |
| | | | Word 1 | | . . . |
| | | | ZMi(m − 7) | | |
| | | | (m − 8) | | |
| | | | | Word 1 | . . . |
| | | | | ZMi(m − 9) | |
| | | | | (m − 10) | |

The m/2 bit pairs (2^{m-1},2^{m-2});(2^{m-3},2^{m-4});(2^{m-5},2^{m-6}) . . . (2¹,2⁰) of each branch metric word are thus clocked successively at half the clock rate interval T/2 into the cascade, starting with the most significant bit pair (2^{m-1},2^{m-2}). This most significant branch metric bit pair will comprise zeros, in the same way as one or more directly subsequent bit pairs as well, since the value of the branch metrics ZMi is less than the accumulated value which the path metrics PMi can reach and to which the bit width m of the processing must be matched. The branch metric bit pairs pass through the pipeline that is formed by the cascade, at the clock frequency 2/T. When the bit 2^{m-1} (that is to say the MSB) of the first branch metric word appears, all of the decision bits for the first cascade stage, that is to say the bits EBPi((m/2)−1) and EBFi((m/2)−1), are set to the binary value 1, and are kept at this value throughout the rest of the time. In the notation of the bit pairs that has been used in the above description relating to FIGS. 11 and 12, the input sequences are: (m/2)-th bit pair; ((m/2)−1))-th bit pair; ((m/2)−2))-th bit pair; . . . ; first bit pair. This means that a “q-th” bit pair contains the bits 2²ⁿ and 2²ⁿ⁺¹, and that a “(q+1 )”-th bit pair contains the bits 2²ⁿ⁺² and 2²ⁿ⁺³, with n extending from 0 to m−1, and q extending from 0 to (m/2)−1.

In the ADD block in each of the q-th processor elements PEi(q), the bit pair 2²ⁿ and 2²ⁿ⁺¹ (q-th bit pair) for the branch metric ZMi are added to the number which is represented by the 4 bits PMMa:d(q). This is a redundant representation of the q-th bit pair for the maximum path metric from the respectively responsible ACSU section. The maximum of the four new path metrics is selected, and the two decision bits EBPi(q) and EBFi(q) are formed for each of the four branches (FIG. 11). The branch metric bit pair in this case covers the value range (0:3)*2ⁿ (the symbol * is the multiplication symbol). The redundant 4-bit representation PMMa:d(q) covers the value range (0:4)*2ⁿ. The output of the ADD block covers the value range (0:7)*2ⁿ, with the carry bit CAi(q) being passed on with the value 4*2ⁿ to the preceding processor element PE(q+1). A path metric representation for a value range (0:4)*2ⁿ is thus formed once again at the input of the MOD block, by the two sum bits SU-0i(q) and SU-1i(q) and the carry bit CAi(q−1) from the subsequent processor element PE(q−1).

The MOD block modifies this numerical representation as follows:

TABLE 7

| Input information from MOD | | | | | Modified representation | | | |
|---|---|---|---|---|---|---|---|---|
| Numerical value | | Input bits | | | (thermometer representation) | | | |
| decimal | dual | SU0 | SU1 | CA | a | b | c | D |
| 0 | 000 | 0 | 0 | 0 | 0 | 0 | 0 | 0 |
| 1 | 001 | 0 | 0 | 1 | 1 | 0 | 0 | 0 |
| | | 1 | 0 | 0 | | | | |
| 2 | 010 | 0 | 1 | 0 | 1 | 1 | 0 | 0 |
| | | 1 | 0 | 1 | | | | |
| 3 | 011 | 1 | 1 | 0 | 1 | 1 | 1 | 0 |
| | | 0 | 1 | 1 | | | | |
| 4 | 100 | 1 | 1 | 1 | 1 | 1 | 1 | 1 |

The representation modified in this way can be used by means of the four 4-OR logic operations in the MAX block to obtain the redundant 4-bit representation PMMa:d(q) of the maximum of the total of four preliminary 4-bit representations PMP1a:d(q), PMP2a:d(q), PMP3a:d(q) and PMP4a:d(q).

The modified representation is a so-called “thermometer” representation, which requires more bits than the binary number representation. In general, a thermometer representation of any given natural number “v” in the numerical range 0:u comprises a u-bit word, with the number “v” being represented by the binary value 1 of all v first bits, counting from a notified end (that is to say from the front or the rear boundary) of the word. A binary number representation requires, as is known, INT[1d(u+1)] bits (that is to say the integer component of the base-2 logerithm of u+1). The greater bit width of the binary number representation and the additional complexity associated with it, in particular for the distribution of the path metrics as well, are, however, justified since the process of forming the maximum is now simple, and the process of making decisions is simple. The maximum is formed as in the case of the known 1-bit architecture by means of an OR logic operation (FIG. 12).

The decision bits EBPi and EBFi are formed in the blocks MOD and VGL using the following rule:

TABLE 8

| EBFi(q + 1) | EBPi(q + 1) | DIFFi(q) | EBFi(q) | EBPi(q) |
|---|---|---|---|---|
| 1 | 1 | ≦−2 | 0 | 0 |
| | | −1 | 1 | 0 |
| | | ≧0 | 1 | 1 |
| 1 | 0 | ≦2 | 0 | 0 |
| | | 3 | 1 | 0 |
| | | 4 | 1 | 1 |
| 0 | 0 | X | 0 | 0 |

In this case, DIFFi(q) indicates the maximum difference between the final path metric PMFi(q) which is represented by the 4 bits PMFia:d(q), and the 3 preliminary path metrics PMj(q), which originate from the three different processor elements PEj(q) and are each represented by the 4 bits PMPja:d(q), where j=1, 2, 3, 4 except for i. The symbol “X” once again means an “indeterminate value”.

If the final decision bit EBFi(q) has the value 0, then this is assessed as information relating to the definitive exclusion of the relevant branch i. The combination EBFi(q)=1 and EBPi(q)=0 is assessed as information relating to intended exclusion. The combination EBFi(q)=1 and EBPi(q)=1 states that the relevant branch will supposedly be the survivor. The preliminary and final decision bits are calculated starting from the most significant bit pair (that is to say the (m/2−1)-th bit pair) and are passed on until, finally, the unambiguous decision is made with the least significant bit pair (that is to say with the 0-th bit pair).

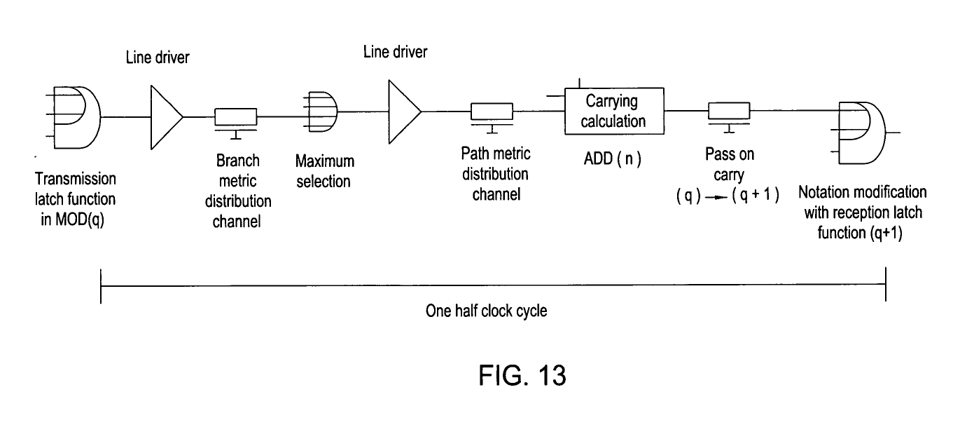

FIG. 13 shows the critical path for the new 2-bit architecture. The number of gates is in this case precisely the same as for the critical path (FIG. 10) with the known 1-bit architecture. However, the gates in the 2-bit architecture are more complex, which could have a disadvantageous effect on the delay time. In order to prevent this, it is particularly advantageous for the gates to make use of dynamic circuit techniques, preferably to make use of the DOMINO logic that is known per se from [6]. If this technique is implemented, the function of the latch circuits LΦA and LΦB, which are shown as separate elements in FIGS. 11 and 12, can be integrated well into the ADD and MOD blocks, respectively. Integration such as this additionally saves delay time.

In the case of “solid-state” logic gates, such as those which have preferably been used until now in particular in integrated circuits, the fully-complementary CMOS technique is used. In this case, the network of controlled switching elements which is switched on or off by the input variables depending on their binary value, is duplicated, on the one hand by means of MOS field-effect transistors with an n-conductive channel (n-FETs) and on the other hand in a complementary manner by means of MOS field-effect transistors with a p-conductive channel (P-FETs). The two networks are connected in series between the supply potentials, and the output variable is tapped off at the junction point. The advantage of this arrangement is that current flows only during the brief time interval in which a state change is taking place at the inputs or at the output. Owing to the large number of transistors, particularly in the case of complex logic functions, however, the space required for gates such as these is rather large. If only a single P-FET is used as a pull-up transistor instead of the complementary P-FET switching network, the space required is admittedly less, but the steady-state pull-up current then requires a large amount of power, and the pull-down process is slowed down. In the case of dynamic logic gates, said switching network is provided only once, to be precise using N-FETs, which occupy less space than P-FETs. A precharging, evaluation and hold circuit is provided instead of the second switching network or a pull-up transistor, and requires only a small number of transistors.

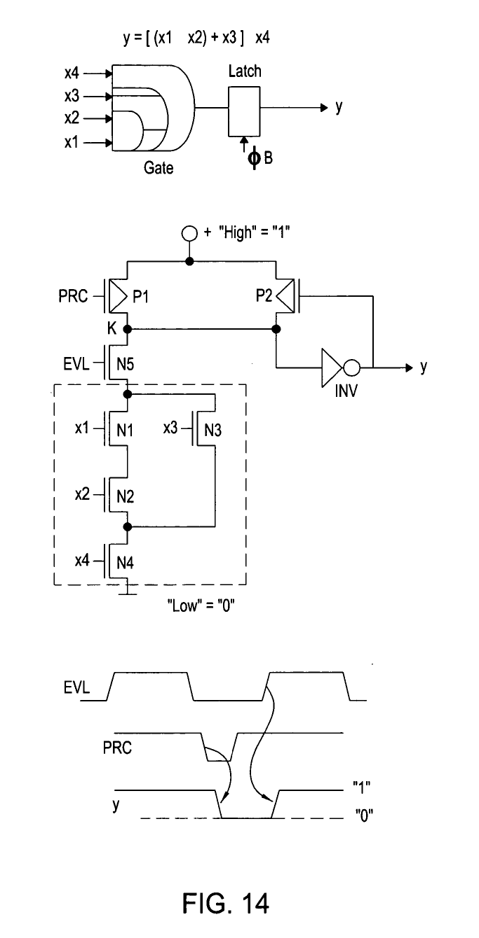

FIG. 14 shows an example of a dynamic circuit technique, specifically for a gate with a logic function based on the Boolean equation:

y=[(x1·x2)+x3]·x4,

as is included repeatedly in the MOD circuit shown in FIG. 12. The symbol · is the operator for the AND logic operation, and the symbol + denotes the OR logic operation.

This “AND-OR-AND” gate is shown in the upper part of FIG. 14 using the normal symbol representation as is used in FIG. 12, together with the downstream latch, which may, for example, be one of the latch circuits LΦB shown in FIG. 12. The central part of the figure shows the configuration of the gate based on a dynamic circuit technique. The switching network which is formed from N-FETs N1, N2, N3 and N4 for the logic function is shown within the dashed boundary frame. The gates of these N-FETs are connected in order to receive the input variables x1, x2, x3 and x4. One end of this switching network is connected to the more negative of the two supply potentials (for example ground), which may be the “low” logic potential for the binary value “0”. The other end is connected via the series circuit comprising an evaluation transistor N5 (which is in the form of an N-FET and can be controlled by an evaluation signal EVL (evaluate)) and a precharging transistor P1 (which is in the form of a P-FET and can be controlled by a precharging signal PRC) to the more positive supply potential, which may be the “high” logic potential for the binary value “1”. Furthermore, a hold circuit is provided, comprising a P-FET P2 which is connected in parallel with the precharging transistor P1, and an inverter INV via which the drain of the P-FET P2 is fed back to the gate. The output variable y is tapped off at the output of the inverter INV.

The lower part of FIG. 14 shows a timing diagram for the signals EVL and PRC, and for the output signal y. The dynamic gate shown in FIG. 14 is operated as follows: a precharging mode is provided first of all for evaluation of the input condition, by first of all changing EVL from a high level to a low level, and by shortly after this changing PRC from a high level to a low level, so that P1 is switched on, and the node K2 between P1 and N5 is at the high level. This results in the output of the inverter INV changing to “0” shortly after this, the PRC once again being at the high level; however, the state of the inverter INV does not change, and K2 remains high, as a result of the feedback via P2. After this precharging mode, the actual evaluation process is carried out by changing EVL back to the high level, so that N5 is switched on. If the input variables satisfy the condition

[(x1·x2)+x3]·x4=1,

then the switching network (within the dashed boundary) has a low impedance, so that the node K changes to the low level, and the inverter produces a “1”. If the above condition is not satisfied, the switching network has a high impedance and the inverter output remains at “0”.

Any desired logic gate can be constructed in the desired manner as a “dynamic” gate using a relatively small number of transistors, by designing the switching network within the dashed boundary frame in accordance with the respectively desired logic function. The complexity for the complex gate circuits in the blocks MOD and ADD in an ACSU according to the invention can thus be kept within acceptable limits. A further advantage is that no dedicated circuits are required at the outputs of the MOD blocks (FIGS. 11 and 12) for the latch circuits, because the latch function can be carried out by the hold circuit (inverter INV and transistor P2), which is provided in any case, at the output of each dynamic gate. For this purpose, the clock signals for the half clock cycles ΦA and ΦB can be formed such that they carry out the role of the evaluation signals EVL at the dynamic gates.

In one advantageous refinement of the invention, the dynamic gates can be designed specifically using the so-called DOMINO technique, as is described in detail in [6]. In this case, the output is precharged to the high level, while the path which leads to the low potential is opened, and the precharging process is stopped while the path to the low potential is activated.

The above description with reference to FIGS. 11 to 14 relates to only one exemplary embodiment of the invention, relating to a Radix-4 trellis. However, the principle of the invention is not restricted to a trellis such as this and may be used in general for all feasible Radix-2^{x} trellises where x≧1. In this case, the number of branch metrics which must be processed for each trellis state, and the number of accumulated path metrics to be compared will, of course, become correspondingly more or less. The number of trellis states may also be greater than or less than 8; 16 or 32 (or even more) trellis states are currently used in practice.

The invention is also not restricted to configuration of a 2-bit architecture, as has been described in detail above as an example. Processor elements in the cascade may also be refined such that they process p>2 branch metric bits simultaneously. A refinement such as this is, of course, likewise within the scope of the invention.

It should also be mentioned that the specific configurations of the blocks ADD, MOD, VGL and MAX as illustrated in FIG. 12 are only examples and preferred embodiments. The critical factor is the logic functions to be provided by these blocks, which may also be formed by circuits other than those shown by way of example.

The ACSU which has been described above by way of example operates by selection of the maximum. If a distance function which requires a selection of the minimum for the survivors is used for determining the branch metrics in the BMU, some logic functions in the ACSU must be inverted. A person skilled in the art will be able to carry out the modifications required for this purpose without any problems.

What is claimed is:

1. A Viterbi decoder for decoding a convolutional code on the basis of a Radix-2^{x} trellis with 2^{z} states, where x and z are integers greater than 1, comprising:
a first calculation unit for calculating 2^{x} branch metrics as m-bit words using periodically successive multibit words in an input sequence for each trellis state;
a second calculation unit having parallel cascades of processor elements for, in a current clock period, adding the 2^{x} branch matrics calculated by the first calculation unit to accumulated 2^{x} path metrics from 2^{x} predecessor trellis states and a selection device for selecting a subset of the 2^{x} path metrics for use as accumulated 2^{x} path metrics in an addition process in a subsequent clock period, wherein the number of processor elements in each of the cascades is less than the number m of the m-bit words; and
a third calculation unit for storage of information obtained from the second calculation unit relating to the identity of the selected path metrics.

2. The Viterbi decoder of claim 1, wherein each of the cascades of the second calculation unit contains a number INT(m/p) of processor elements, where p is an integer equal to or greater than 2 and less than m.

3. The Viterbi decoder of claim 2, wherein each of the INT(m/p) processor elements within a cascade are associated with one, and only one, of INT(m/p) successive disjunct p-bit groups of the m bits.

4. The Viterbi decoder of claim 2, wherein the numbers m and p are such that m/p is an integer.

5. The Viterbi decoder of claim 2, wherein the numbers m and p are such that m/p is not an integer and in addition to the INT(m/p) processor elements, each cascade further comprises an additional processor element associated with that an r-bit group which is formed as the remainder after removal of the INT(m/p) p-bit groups.

6. The Viterbi decoder of claim 5, wherein the additional processor element is associated with the r most significant bits or with the r least significant bits of the m bits.

7. The Viterbi decoder of claim 1, wherein each processor element comprises an addition device for generating a sum of two numbers, one of which is represented as a binary number by an associated group of branch metrics bits and the other of which is a redundant representation of the associated group of the bits of a previously selected path metric.

8. The Viterbi decoder of claim 7, wherein each processor element further comprises a modification device which receives as input variables the p least significant bits of said sum, the carry bit from the addition device of the processor element next in the cascade, a preliminary decision bit and a final decision bit from the processor element preceding it in the cascade, in order to produce a redundant representation of the associated group of bits in a preliminary path metric and a redundant representation of the associated group of bits in a final path metric.

9. The Viterbi decoder of claim 8, wherein each processor element further comprises a comparison device for forming the preliminary decision bit and the, final decision bit for the subsequent processor element by linking the final path metric representation from the relevant processor element with the 2^{x}−1 preliminary path metric representations from other processor elements of the same order.

10. The Viterbi decoder of claim 8, wherein:
a first latch register is provided between the outputs of the addition device and the inputs of the modification device;
a second latch register is provided at the outputs of the modification device; and
the two latch registers are clocked with an offset of half a period of a clock rate.

10. The Viterbi decoder of claim 8, wherein:
the redundant representations are thermometer representations, each comprising a u-bit word, where u is the most significant of the natural number to be represented, and the actual value v is represented by a same preselected binary value for all, and only all, of the v first bits; and
the selection device contains a number u of logical OR gates, each of which receives the 2^{x} bits of the same order from the thermometer representations of those preliminary path metric bits which are associated with the relevant group of branch metric bits, so that each of said OR gates produces at its output one of the u bits in the thermometer representation of the associated bit group in the previously accumulated extreme path metric.

11. The Viterbi decoder of claim 10, wherein p=2 and u=4.

12. A Viterbi decoder for decoding a convolutional code on the basis of a Radix-2^{x} trellis with 2^{z} states, where x and z are integers ≧1, comprising:
a first calculation unit which uses periodically successive multibit words in an input sequence for each trellis state to calculate the 2^{x} branch metrics as multibit words; and
a second calculation unit which, for each trellis state in each clock period, adds the respectively associated 2^{x} branch metrics to the already accumulated 2^{x} path metrics from 2^{x} predecessor trellis states and selects those of the 2^{x} path metrics which have been determined in a preselected sense to be as extreme as the new accumulated path metric for the addition process in the next period, wherein the second calculation unit contains, for each trellis state: a number 2^{x} of parallel cascades of processor elements which are connected in series for pipeline processing of the bits in the branch metrics and in the extreme path metrics, progressively with decreasing significance value of the bits, and in each case one extreme value selection device for all the processor elements of the same order within the pipeline, and the number of processor elements in each of the cascades is less than the number m of bits which are used for the binary number representation of the value range of the path metrics.

13. The Viterbi decoder of claim 12, wherein each of the cascades of the second calculation unit contains one number INT(m/p) of processor elements which corresponds to the integer number of m/p, where p is an integer that is at least equal to 2 and is less than m, and where each of these INT(m/p) processor elements within the cascade is associated with one, and only one, of INT(m/p) successive disjunct p-bit groups of the m bits.

14. The Viterbi decoder of claim 13, wherein the numbers m and p have magnitudes such that m/p is an integer.

15. The Viterbi decoder of claim 13, wherein m/p is not an integer, and wherein, in addition to the INT(m/p) processor elements, each cascade contains an additional processor element which is associated with an r-bit group which is formed as the remainder after removal of the INT(m/p) p-bit groups.

16. The Viterbi decoder of claim 15, wherein the further processor element is associated with the r most significant bits or with the r least significant bits of the m bits.

17. The Viterbi decoder of one of claims 12, wherein each processor element comprises:
an addition device for formation of the sum of two numbers, which is represented as a binary number, one of which is represented as a binary number by the associated group of branch metrics bits and-the other of which is a redundant representation of the associated group of the bits of the previously accumulated extreme path metric;
a modification device which receives as input variables the p least significant bits of said sum and the carry bit from the addition device of the processor element which is next in the cascade, as well as a preliminary and a final decision bit from the processor element which precedes it in the cascade, in order to produce a redundant representation of the associated group of bits in a preliminary path metric and a redundant representation of the associated group of bits in a final path metric; and
a comparison device which, by linking the final path metric representation from the relevant processor element with the 2^{x}−1 preliminary path metric representations from the other processor elements of the same order, forms the preliminary decision bit and the final decision bit for the subsequent processor element.

18. The Viterbi decoder of claim 17, further comprising:
a first latch register between the outputs of the addition device and the inputs of the modification device; and
a second latch register at the outputs of the modification device, wherein the two latch registers are clocked with an offset of half the period of the clock rate.

19. The Viterbi decoder of one of claims 17, wherein:
the redundant representations are thermometer representations, each comprising a u-bit word, where u is the most significant of the natural number to be represented, and the actual value v is represented by a same preselected binary value for all, and only all, of the v first bits, counting from a preselected end of the word; and
each extreme value selection device contains a number u of logical OR gates, each of which receives the 2^{x} bits of the same order from the thermometer representations of those preliminary path metric bits which are associated with the relevant group of branch metric bits, so that each of said OR gates produces at its output one of the u bits in the thermometer representation of the associated bit group in the previously accumulated extreme path metric.

20. The Viterbi decoder of claim 12, wherein the extreme path metrics are the respective maximum path metrics.
